(19) United States
(12) Patent Application Publication
(10) Pub. No.: US 2003/0204810 A1
(43) Pub. Date: Oct. 30, 2003

(54) Real time webpage editing system and method with auxiliary pattern

(76) Inventors: Xi-Nam Dam, Dalian (CN); Hong-Wei Bi, Dalian (CN); Wang-Yang Du, Dalian (CN)

Correspondence Address: BIRCH STEWART KOLASCH & BIRCH, PO BOX 747, FALLS CHURCH, VA, 22040-0747, US

(21) Appl. No.: 10/270,347

(22) Filed: Oct. 15, 2002

(30) Foreign Application Priority Data
Apr. 24, 2002 (TW) 091108415

(51) Int. Cl. G06F 15/16

(52) U.S. Cl. 715/500

(57) ABSTRACT

A real time webpage editing system with auxiliary pattern and the method therefor are disclosed. The user uses a browser to connect to the disclosed system through a network. With the assistance of web page templates that allow users to make adjustments and the what-you-see-is-what-you-get (WYSIWYG) interface, the user is able to edit the web page contents in real time. The edited web page is then dynamically processed and stored by the system.

### BACKGROUND OF THE INVENTION

1. Field of Invention

The invention relates to a network application service system and the method therefor. In particular, the invention pertains to a system that provides pattern assistance and the what-you-see-is-what-you-get (WYSIWYG) interface for real time web page editing and has dynamic processing and updating abilities.

2. Related Art

In the past, the web page editing task usually relies upon profesionals using special application programs. The completed web pages are then moved to an appropriate directory in the server for web services. However, this method has a complicated procedure. It does not only cause the user a lot of troubles but also wastes much time. Furthermore, in order to accomplish web page editing, the user has to possess many technical skills. Therefore, for normal users without much technical computer background, the prior art sets such a high threshold that web page editing is not easy at all. Since the web page editing and browsing are executed separately, the user often cannot see the possible effects generated by the web page currently being edited. It is often the case that the web page effects are different from what the editer expects. Inevitably, the user has to repeat the editing and checking processes over and over again, multiplying the time in web page editing.

There are some utilities designed for professional web page editing. They simplify the editing process and save time by providing web page patterns so that more ordinary users can easily edit the web page contents. However, this method still cannot effectively solve the problems of separate web page editing and execution processes and thus the low efficiency. Moreover, the web page patterns provided by such utilities are of fixed styles and cannot be modified at the user's will. Therefore, the user's innovative ideas will be greatly limited.

As more hardware and software techniques become available, how to fully utilize the convenience and other properties of the network along with related technologies to simplify the procedure of web page editing is an important issue. The new method should allow users without too much computer knowledge to easily edit web page contents in the what-you-see-is-what-you-get (WYSIWYG) fashion. It should further provide an editing environment that has dynamic processing and updating abilities.

### SUMMARY OF THE INVENTION

In view of the foregoing, the invention provides a real time webpage editing system with auxiliary pattern and the method therefor. An objective of the invention is to provide varied web page patterns that allow the user to make adjustments. The disclosed system and method assists the user to edit web page contents using a browser in the WYSIWYG fashion.

Another objective of the invention is to provide dynamic processing of web page editing and a real time updating environment so as to simplify the editing procedure and increase the efficiency.

To achieve the above-mentioned objectives, the disclosed real time webpage editing system with auxiliary pattern includes a web page contents database, a web page pattern module, an extraction and storage module, a transmission and reception module, and an editing module.

On the other hand, the disclosed real time webpage editing method with auxiliary pattern includes the steps of: establishing connection through a login procedure and entering a real time web page editing system; the user's selecting a web page pattern and sending the contents back to the system; the user's selecting an editable block in the selected web page pattern; the system's displaying an editing window for the selected editable block and starting an editing process; and receiving and processing edited web page contents to produce in real time the web page contents and further storing and displaying the web page contents. in real time the web page contents and further storing and displaying the web page contents.

### BRIEF DESCRIPTION OF THE DRAWINGS

The invention will become more fully understood from the detailed description given hereinbelow illustration only, and thus are not limitative of the present invention, and wherein:

FIG. 1 shows the structure of the real time webpage editing system with auxiliary pattern and the corresponding method according to the invention;

FIG. 2 is a flowchart of the disclosed real time webpage editing system and method with auxiliary pattern;

FIG. 3-a is a schematic view of the disclosed real time webpage editing system and method with auxiliary pattern;

FIG. 3-b is another schematic view of the disclosed real time webpage editing system and method with auxiliary pattern;

FIG. 3-c is yet another schematic view of the disclosed real time webpage editing system and method with auxiliary pattern; and

FIG. 3-d is yet another schematic view of the disclosed real time webpage editing system and method with auxiliary pattern.

### DETAILED DESCRIPTION OF THE INVENTION

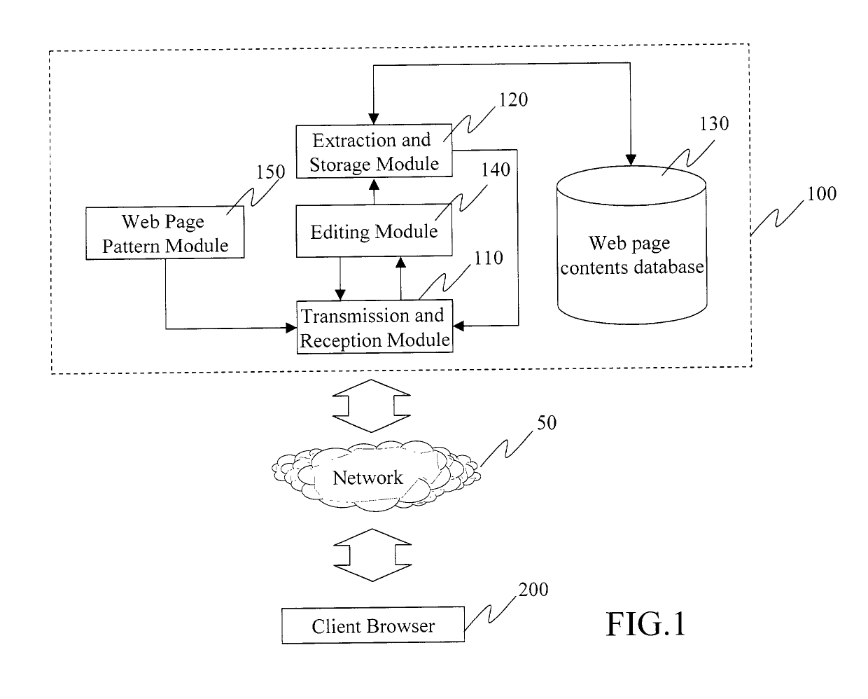

A real time webpage editing system with auxiliary pattern and the method therefor are described in the following paragraphs. A user uses a client browser 200 to connect with the disclosed real time web page editing system 100 through a network 50 for editing web page contents. We use FIG. 1 to explain the structure of the disclosed system. The system 100 has a transmission and reception module 110, an extraction and storage module 120, a web page contents database 130, an editing module 140, and a web page pattern module 150.

(1) The transmission and reception module 110 receives user's requests sending from the client browser 200 and returns contents pursuant to the requests. The module further contains web page contents stored in the web page contents database 130, web page patterns provided by the web page pattern module 150, and newly generated web page contents processed by the editing module 140.

(2) The extraction and storage module 120 extracts the originally stored web page contents from the web page contents database 130 in accord with the user's request. It also stores the newly generated web page contents processed by dynamic editing in the web page contents database 130 while the user is editing.

(3) The web page contents database 130 stores all web page contents comprising different types of elements such as texts, pictures, videos, voices and tables.

(4) The editing module 140 receives editing contents sent from the client browser 200 and then changes the corresponding program code (including addition, modification, and deletion). The dynamically processed web page contents are sent back to the client browser 200 for the user to browse and perform subsequent editing.

(5) The web page pattern module 150 provides the user patterns of web pages. Each pattern usually has many editable blocks for the user to adjust and set the contents and parameters through the editing process, including adding, deleting, adjusting, moving and replacing operations. The replacing operation refers to changing the editing attribute of the editable block. For example, the text block can be substituted with a picture block or a video block with a text block.

In order for the real time web page editing system 100 to confirm the valid identity of the user, it further provides a login procedure to verify the user's identity by asking a login name and a corresponding password. Only after the user passes the login procedure can he or she enter the disclosed system 100 to perform real time web page editing.

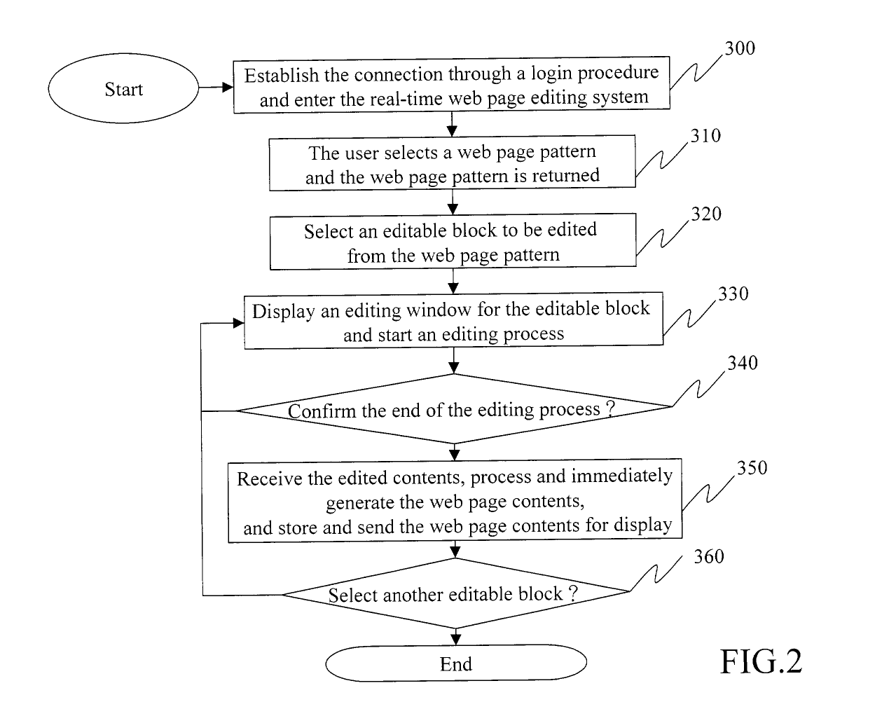

With reference to FIG. 2, the disclosed method is described as follows. First, a user goes through a login procedure through a client browser 200 (i.e. verifyng the user's login name and password). After the client browser 200 and the disclosed real time web page system 100 establish a connection, the user enters the real time web page system 100 (step 300). The user selects a preferred web page pattern from a pattern database provided by the web page pattern module 150. The system then sends the selected web page contents back for the user to perform real time web page editing (step 310). Each web page pattern comprises many editable blocks. The user can furthe performing adding, deleting, adjusting, moving, and type replacement on editable blocks if the provided pattern is not satisfactory. The user can then select one of the editable blocks to edit (step 320). During the selection process, the disclosed real time web page editing system 100 automatically detects the location of the cursor as it is moved by the user among the editable blocks and prompts a functional menu for the corresponding editable block. When the user clicks to select a editable block, the system pops up a window for displaying the selected block, and the user edits contents and sets parameters therein (step 330). At the moment, the system determines whether the user clicks the confirm key of the editing window to finish the editing process (step 340). If not, the system stays in step 330 for the user to continue editing. Once the user clicks the confirm key, the system receives the edited contents and perform dynamic editing, i.e., adding, deleting or modifying the web page code according to the edited contents. The new web page contents are immediately generated, stored, and sent back to the client browser 200 for display (step 350) so that the user can check the edited result. Afterwards, the system determines whether the user continues the select another editable block (step 360). If so, the system returns to step 330 for the user to perform other editing jobs; otherwise, the web page editing process finishes.

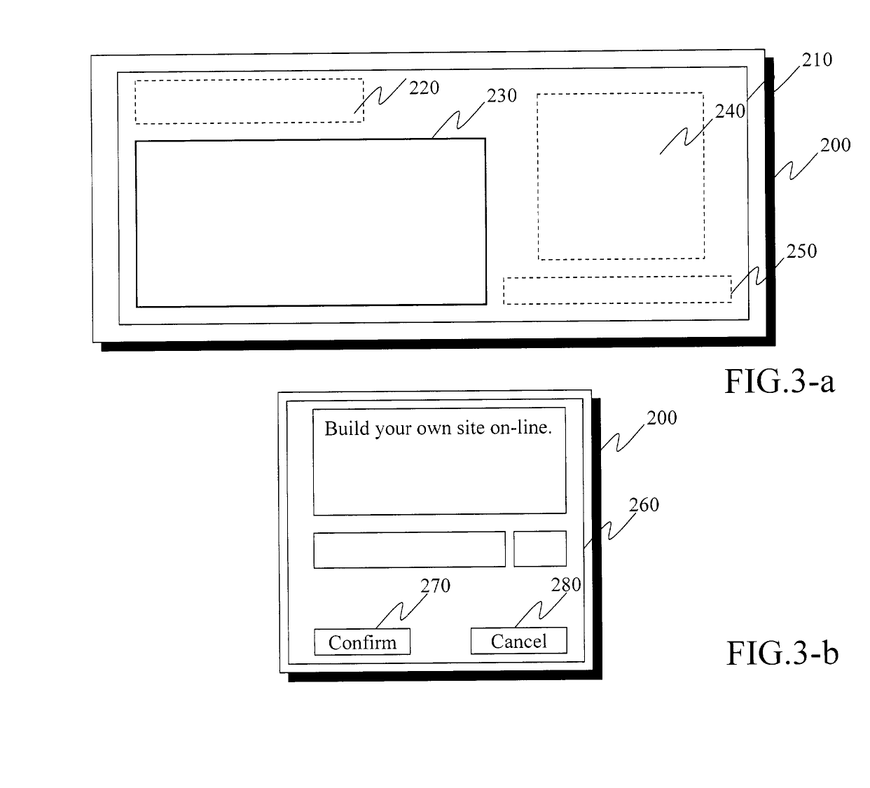

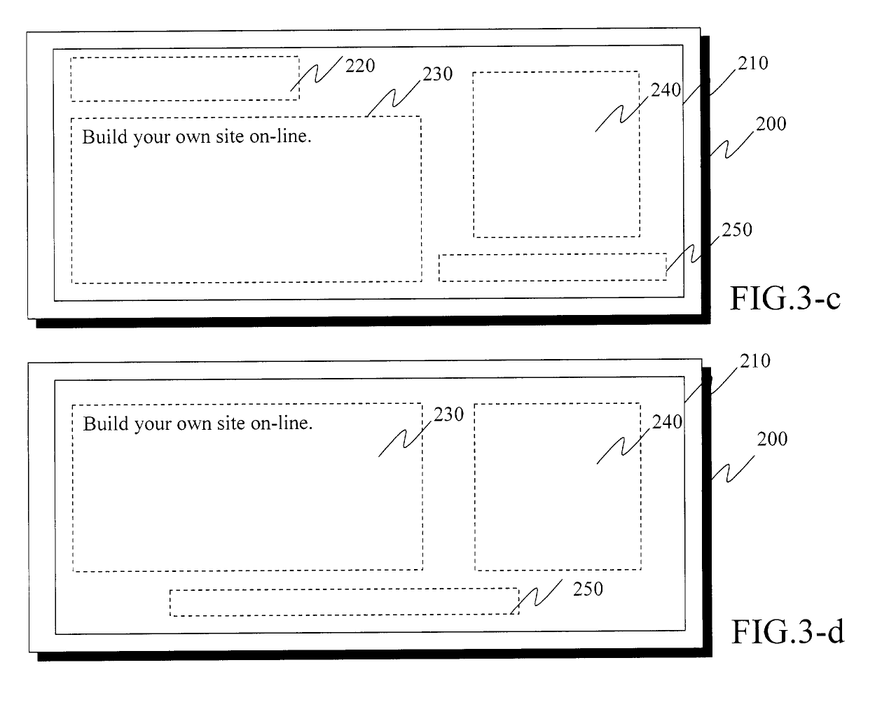

Finally, we use FIGS. 3-a, 3-b, 3-c, and 3-d to demonstrate the feasibility of the invention.

In FIG. 3-a, one sees that the user selected web page pattern 210 contains four editable blocks (including the block A 220, the block B 230, the block C 240, and the block D 250). If the user wants to edit the block B 230, he or she can move the cursor onto the block B 230. The system then highlights the range of the editable block B 230 (for example, the block B 230 in FIG. 3-a is highlighted using thick solid lines, while the rest blocks are enclosed by dashed lines). When the user selects to enter the editing process of the block B 230, the system pops up a window 260 to display the selected editable block (see FIG. 3-b) for the user to edit. The user edits contents and sets parameters in the editable block B 230 through the window 260 (e.g., the user adds the text “Build your own site on-line”). Clicking the confirm key 270 means the editing process is over (or the user can click the cancel key 280 to abandon the editing task). After the system performs dynamic processing, the newly generated web page contents are sent back to the client browser 200 for the user to perform other editing processes (see FIG. 3-c). If the user is not satisfied with the combination provided by the web page pattern 210, the user can arbitrarily add, adjust, move and replace the contents. For example, the user deletes the editable block A 220, moves the block B 230, and modify the block D 250 in FIG. 3-d. From these drawings, one can see that the whole real time web page editing process is performed in the “what-you-see-is-what-you-get” (WYSIWYG) fashion.

In fact, the disclosed real time web page editing system 100 can employ the concept and technique of layers in the provided web page patterns, so that each editable block further allows the user to overlap blocks in addition to arbitrarily adding, deleting, adjusting, moving and type replacement. This makes the combinations of web page patterns more flexible. For instance, a text editable block can be overlaid on a picture editable block, producing the effect of “a text embedded in a picture.” Alternatively, one can also overlay a picture editable block on a text editable block to achieve the effect of “a picture enclosed by a text.”

### Effects of the Invention

The disclosed real time webpage editing system with auxiliary pattern and method enables users to perform real time web page contents editing simply through a browser. With the assistance of varied tunable web page patterns provided by the invention, the user does not need to have too much technical computer knowledge or skills. Nor will the user waste a lot of time in the complicated editing procedure as in the prior art. Moreover, the user can arbitrarily add, delete, adjust, move and change types of the editable blocks to create a desired web page.

In addition, using the WYSIWYG display means, the user can control the web page contents while at the same time understanding the execution of the web page. Finally, through the dynamic processing and real time updating environment in the disclosed system, the latest editing result can be immediately presented in front of the user, achieving the real time editing effect.

What is claimed is:

1. A real time webpage editing system with auxiliary pattern for a user to use a browser to establish connection through a network and to perform real time editing on the web page contents with the assistance of patterns and what-you-see-is-what-you-get (WYSIWYG) display, the system comprising:
a web page contents database, which stores at least one web page;
a web page pattern module, which provides a web page pattern for web page editing;
an extraction and storage module, which immediately extracts and stores web page contents edited by the user;
a transmission and reception module, which receives a request from the user and provides the web page contents and the web page pattern; and
an editing module, which edit a corresponding program code according to an editing operation result and produces the processed web page contents.

2. The system of claim I further comprising a login procedure of using a user name and a corresponding password to verify the user's identity.

3. The system of claim 1, wherein each of the web page patterns comprises a plurality of editable blocks.

4. The system of claim 1, wherein the editing operation refers to the operation of calling an editing window corresponding to the editable block and setting parameters inside the editable block.

5. The system of claim 1, wherein the process of editing a corresponding program code according to an editing operation result refers to addition, deletion and modification of the corresponding program code.

6. The system of claim 1, wherein the system further detects the location of the cursor and highlights the editable block where the cursor is.

7. The system of claim 1 further comprising the procedure to perform adding, deleting, adjusting, moving and type replacement operations on the editable blocks.

8. The system of claim 7, wherein the type replacement refers to the conversion of the editable blocks among different attributes consisting of at least text, picture, video, and voice.

9. A real time webpage editing method with auxiliary pattern for a user to use a browser to establish connection through a network and to perform real time editing on the web page contents with the assistance of patterns and what-you-see-is-what-you-get (WYSIWYG) display, the method comprising:
establishing connection through a login procedure to enter a real time web page editing system;
the user's selecting a web page pattern and returning the selected web page pattern;
selecting an editable block to be edited from the web page pattern;
displaying an editing window for the selected editable block and starting an editing operation; and
receiving the edited contents, processing to generate web page contents, and storing and returning the web page contents for display.

10. The method of claim 9, wherein the login procedure requires the input of a user name and a corresponding password.

11. The method of claim 9, wherein each of the web page patterns comprises a plurality of editable blocks.

12. The method of claim 9, wherein the editing operation refers to the operation of calling an editing window corresponding to the editable block and setting parameters inside the editable block.

13. The method of claim 9, wherein the processing refers to addition, deletion and modification of the corresponding program code of the web page according to the contents of the editing operation.

14. The method of claim 9 further comprising the step of detecting the location of the cursor and highlighting the editable block where the cursor is.

15. The method of claim 9 further comprising the step of performing adding, deleting, adjusting, moving and type replacement operations on the editable blocks.

16. The method of claim 15, wherein the type replacement refers to the conversion of the editable blocks among different attributes consisting of at least text, picture, video, and voice.

17. A real time webpage editing system with auxiliary layer pattern for a user to use a browser to establish connection through a network and to perform real time editing on the web page contents with the assistance of layer patterns and what-you-see-is-what-you-get (WYSIWYG) display, the system comprising:
a web page contents database, which stores at least one web page;
a web page pattern module, which provides a web page pattern for web page editing;
an extraction and storage module, which immediately extracts and stores web page contents edited by the user;
a transmission and reception module, which receives a request from the user and provides the web page contents and the web page pattern; and
an editing module, which edit a corresponding program code according to an editing operation result and produces the processed web page contents.

18. The system of claim 17, wherein each of the web page patterns comprises a plurality of editable blocks, each of the editable blocks utilizing a layer technique for performing addition, deletion, adjustment, movement, type replacement thereon.

19. The system of claim 18, wherein the layer technique allows the overlapping of the different editable blocks.

20. The system of claim 18, wherein the type replacement refers to the conversion of the editable blocks among different attributes consisting of at least text, picture, video, and voice.

21. A real time webpage editing method with auxiliary layer pattern for a user to use a browser to establish connection through a network and to perform real time editing on the web page contents with the assistance of patterns and what-you-see-is-what-you-get (WYSIWYG) display, the method comprising:
establishing connection through a login procedure to enter a real time web page editing system;
the user's selecting a web page pattern and returning the selected web page pattern;
selecting an editable block to be edited from the web page pattern;
displaying an editing window for the selected editable block and starting an editing operation; and
receiving the edited contents, processing to generate web page contents, and storing and returning the web page contents for display.

22. The method of claim 21, wherein each of the editable blocks utilizes a layer technique for performing addition, deletion, adjustment, movement, type replacement thereon.

23. The method of claim 22, wherein the layer technique allows the overlapping of the different editable blocks.

24. The method of claim 22, wherein the type replacement refers to the conversion of the editable blocks among different attributes consisting of at least text, picture, video, and voice.
